(19) United States
(12) Patent Application Publication
(10) Pub. No.: US 2018/0375444 A1
(43) Pub. Date: Dec. 27, 2018

(54) BUILDING SYSTEM WITH VIBRATION BASED OCCUPANCY SENSORS

(71) Applicant: Johnson Controls Technology Company, Plymouth, MI (US)

(72) Inventor: Timothy C. Gamroth, Dousman, WI (US)

(73) Assignee: Johnson Controls Technology Company, Plymouth, MI (US)

(21) Appl. No.: 15/631,830

(22) Filed: Jun. 23, 2017

(51) Int. Cl. H02N 2/18; H04L 12/28; G05B 19/042

(52) U.S. Cl. CPC H02N 2/188; H04L 12/2829; H04Q 9/00; H02N 2/181; G05B 19/0426

(57) ABSTRACT

An occupancy sensing device for determining occupancy of a zone of a building includes a first vibration sensor, a second vibration sensor, and a processing circuit. The first vibration sensor is configured to sense vibrations associated with movement of an occupant and generate a first signal based on the sensed vibrations. The second vibration sensor is configured to sense the vibrations associated with the movement of the occupant and generate a second signal based on the sensed vibrations. The processing circuit is configured to receive the first signal from the first vibration sensor, receive the second signal from the second vibration sensor, and determine whether the occupant is entering or exiting the zone based on the first and second signals.

### BACKGROUND

In building systems, occupancy of a building can be determined based on occupancy sensors. Occupancy sensors can be used to identify the presence or absence of an occupant in a particular area of the building. Occupancy sensors may be one of two types, motion detectors and proximity sensors. Motion detectors can be configured to detect movement in a zone. Proximity sensors can be configured to determine the distance between a target (otherwise referred to as an occupant) and the proximity sensor itself. Occupancy sensors may be passive infrared (PIR) sensors that detect the difference in heat between background heat and heat emitted by people. Occupancy sensors can further include cameras, keycard access points, and radar. These occupancy sensors may analyze images and videos, aggregate information from scanned keycards, or use electromagnetic waves to detect occupancy.

### SUMMARY

One implementation of the present disclosure is an occupancy sensing device for determining occupancy of a zone of a building. The device includes a first vibration sensor, a second vibration sensor, and a processing circuit. The first vibration sensor is configured to sense vibrations associated with movement of an occupant and generate a first signal based on the sensed vibrations. The second vibration sensor is configured to sense the vibrations associated with the movement of the occupant and generate a second signal based on the sensed vibrations. The processing circuit is configured to receive the first signal from the first vibration sensor, receive the second signal from the second vibration sensor, and determine whether the occupant is entering or exiting the zone based on the first and second signals.

In some embodiments, the first vibration sensor and the second vibration sensor are located a predefined distance apart, the predefined distance being between one inch and five feet.

In some embodiments, the occupancy sensing device is located under a floor of the building at an entry or exit point of the zone. The first and second vibration sensors can sense vibrations associated with the occupant walking on the floor.

In some embodiments, the first vibration sensor and the second vibration sensor are located in a position that is at least one of under a floor of the building, on top of the floor of the building, and within the floor of the building.

In some embodiments, the first vibration sensor and the second vibration sensor are located under a floor of the building at a door frame. In some embodiments, the first vibration sensor and the second vibration sensor are positioned substantially parallel with a direction of movement of the occupant as the occupant enters or exits the zone and are positioned substantially perpendicular with a head board of the door frame.

In some embodiments, the first vibration sensor and the second vibration sensor are positioned such that the distance between the occupant and the first vibration sensor is greater than the distance between the occupant and the second vibration sensor as the occupant exits the zone. In some embodiments, the first vibration sensor and the second vibration sensor are positioned such that the distance between the occupant and the second vibration sensor is greater than the distance between the occupant and the first vibration sensor as the occupant enters the zone.

In some embodiments, the first vibration sensor and the second vibration sensor are positioned such that the first signal leads the second signal in time when the occupant enters the zone and the second signal leads the first signal in time when the occupant exits the zone. In some embodiments, the processing circuit is configured to determine whether the first signal leads the second signal in time or the second signal leads the first signal in time and determine whether the occupant is entering or exiting the zone based on whether the first signal leads the second signal in time or the second signal leads the first signal in time.

In some embodiments, the processing circuit is configured to determine a number of occupants in the zone by incrementing the number of occupants in the zone in response to determining that the occupant is entering the zone and decrementing the number of occupants in the zone in response to determining that the occupant is exiting the zone.

In some embodiments, the processing circuit is configured to operate equipment associated with the zone based on the number of occupants in the zone.

In some embodiments, the processing circuit is configured to determine a load based on the number of occupants in the zone and control equipment associated with the zone based on the load, the equipment including heating, ventilation, and air-conditioning (HVAC) equipment.

In some embodiments, the processing circuit is configured to determine whether the occupant is entering or exiting the zone based on a magnitude difference between the first and second signals.

In some embodiments, the processing circuit is configured to communicate occupancy data to a controller. In some embodiments, the occupancy data includes information indicating whether the occupant is entering or exiting the zone.

In some embodiments, the processing circuit is configured to operate in a learning mode by recording data based on the first and second signals as the occupant enters the zone a predefined number of times and exits the zone a predefined number of times and use the recorded data to determine whether another occupant is entering or exiting the zone.

Another implementation of the present disclosure is a method for determining the occupancy of a zone. The method includes receiving a first signal from a first vibration sensor, wherein the first signal is generated by the first vibration sensor based on vibrations associated with movement of an occupant. The method further includes receiving a second signal from a second vibration sensor, wherein the second signal is generated by the second vibration sensor based on the vibrations associated with the movement of the occupant. The method further includes determining whether the occupant is entering or exiting the zone based on the first and second signals and determining a number of occupants in the zone based on whether the occupant is entering or exiting the zone. The method further includes controlling equipment associated with the zone based on the number of occupants in the zone, the equipment including heating, ventilation, and air-conditioning (HVAC) equipment.

In some embodiments, the first vibration sensor and the second vibration sensor are positioned such that the first signal leads the second signal in time when the occupant enters the zone and the second signal leads the first signal in time when the occupant exits the zone. In some embodiments, the method further includes determining whether the first signal leads the second signal in time or the second signal leads the first signal in time and determining whether the occupant is entering or exiting the zone based on whether the first signal leads the second signal in time or the second signal leads the first signal in time.

In some embodiments, the method further including determining the number of occupants in the zone by incrementing the number of occupants in the zone in response to determining that the occupant is entering the zone and decrementing the number of occupants in the zone in response to determining that the occupant is exiting the zone.

Another implementation of the present disclosure is a system for sensing occupancy in a zone of a building. The system includes a first vibration sensor configured to sense vibrations associated with movement of an occupant and generate a first signal based on the sensed vibrations and a second vibration sensor is configured to sense the vibrations associated with the movement of the occupant and generate a second signal based on the sensed vibrations. The first vibration sensor and the second vibration sensor are located a predefined distance apart. The first and second vibration sensors are located at an entry or exit point of the zone and are configured to sense vibrations associated with the occupant walking on a floor. The system includes a processing circuit configured to receive the first signal from the first vibration sensor, receive the second signal from the second vibration sensor, determine whether the occupant is entering or exiting the zone based on the first and second signals, and communicate occupancy data to a controller, the occupancy data including information indicating whether the occupant is entering or exiting the zone.

In some embodiments, the first vibration sensor and the second vibration sensor are located under the floor at a door frame. In some embodiments, the first vibration sensor and the second vibration sensor are positioned substantially parallel with a direction of movement of the occupant as the occupant enters or exits the zone and are positioned substantially perpendicular with a head board of the door frame.

In some embodiments, the first vibration sensor and the second vibration sensor are positioned such that the distance between the occupant and the first vibration sensor is greater than the distance between the occupant and the second vibration sensor as the occupant exits the zone. In some embodiments, the first vibration sensor and the second vibration sensor are positioned such that the distance between the occupant and the second vibration sensor is greater than the distance between the occupant and the first vibration sensor as the occupant enters the zone.

In some embodiments, the first vibration sensor and the second vibration sensor are positioned such that the first signal leads the second signal in time when the occupant enters the zone and the second signal leads the first signal in time when the occupant exits the zone. In some embodiments, the processing circuit is configured to determine whether the first signal leads the second signal in time or the second signal leads the first signal in time and determine whether the occupant is entering or exiting the zone based on whether the first signal leads the second signal in time or the second signal leads the first signal in time.

In some embodiments, the processing circuit is configured to determine a number of occupants in the zone by incrementing the number of occupants in the zone in response to determining that the occupant is entering the zone and decrementing the number of occupants in the zone in response to determining that the occupant is exiting the zone.

### BRIEF DESCRIPTION OF THE DRAWINGS

FIG. 1 is a drawing of a building equipped with a HVAC system, according to an exemplary embodiment.

FIG. 2 is a block diagram of a waterside system that may be used in conjunction with the building of FIG. 1, according to an exemplary embodiment.

FIG. 3 is a block diagram of an airside system that may be used in conjunction with the building of FIG. 1, according to an exemplary embodiment.

FIG. 4 is a block diagram of a building automation system (BAS) that may be used to monitor and/or control the building of FIG. 1, according to an exemplary embodiment.

FIG. 5 is a diagram of a plurality of vibration sensor units in a plurality of zones of the building of FIG. 1, according to an exemplary embodiment.

FIG. 6A is a block diagram of one of the vibration sensor units of FIG. 5 communicating occupancy data to a controller, according to an exemplary embodiment.

FIG. 6B is a block diagram of the vibration sensor unit of FIG. 5, the vibration sensor unit including a controller, according to an exemplary embodiment.

FIG. 7A is a block diagram shown from a side view of a one of the vibration sensor units of FIG. 5 located under a floor of the building of FIG. 1 detecting an occupant, according to an exemplary embodiment.

FIG. 7B is a block diagram from a top view of a one of the vibration sensor units of FIG. 5 located under a floor of the building of FIG. 1 detecting an occupant, according to an exemplary embodiment.

FIG. 8 is a block diagram of one of the vibration sensor units of FIG. 5 shown in greater detail, according to an exemplary embodiment.

FIG. 9 is a block diagram of a plurality of the vibration sensor units of FIG. 5 communicating occupancy data to a controller, according to an exemplary embodiment.

FIG. 10 is a flow diagram of a process for determining a number of occupants in a zone based on occupancy data determined by one or more vibration sensor units of FIG. 8, according to an exemplary embodiment.

FIG. 11 is a flow diagram of a process for determining a number of occupants in a zone with a controller, according to an exemplary embodiment.

### DETAILED DESCRIPTION

### Overview

Referring generally to the FIGURES, a building system with vibration based occupancy sensors is shown, according to various exemplary embodiments. More particularly, the figures illustrate a vibration sensor unit that can be configured to detect occupancy based on sensed vibrations. The vibration sensor unit senses vibrations in a floor or other surface that are the result of occupants walking or moving throughout a building. The vibration sensor unit can include two vibration sensors. These vibration sensors may generate signals based on the vibrations which the sensors detect. These vibration sensors may be piezoelectric vibration sensors, accelerometers, or other types of vibration sensors.

The two sensors of the vibration sensor unit may be separated by a predefined amount. Further, the two sensors of the vibration sensor unit can be oriented to be parallel with the direction of travel of an occupant. Further, if the vibration sensor unit is located under the floor at a doorway, the two vibration sensors may be separated by a predefined distance, the predefined distance being perpendicular with a head board of the door frame. This orientation for occupants to be closer to one or the other of the two vibration sensors when the occupant is entering or exiting through the doorway.

Since the occupants may be closer to one of the two vibration sensors and there is a predefined distance separating the two vibration sensors, the two signals generated by the two sensors may be different. More particularly, the signals may differ in time and magnitude. Since the occupant is closer to one of the vibration sensors, the signal of the closer vibration sensor unit may have a higher magnitude. Further, since the vibrations created by the occupant may reach the closer vibration sensor before the farther away vibration sensor, there may be a time shift in the two signals. The signal generated by the closer vibration sensor may lead the signal generated by the farther away vibration sensor.

Based on the characteristics of the two signals, a processing circuit of the vibration sensor unit (or other controller) can be configured to determine whether an occupant is entering or exiting a zone. Based on this determination, the processing circuit can be configured to maintain an occupant count in a particular zone. For example, if the vibration sensor unit is located at the entrance to a particular zone, anytime that the processing circuit determines that an occupant has entered the zone, the processing circuit can increment a total number of occupants in the zone. In response to the processing circuit determining that an occupant has exited the zone, the processing circuit can decrement the total number of occupants in the zone.

In various embodiments, a zone may have multiple exit and entry points. In this regard, there may be multiple vibration sensors for a particular zone. These vibration sensors can be located, one at each of the entry or exit points of the zone. In some embodiments, the plurality of vibration sensors communicate to determine the occupancy of the zone. For example, each vibration sensor unit may receive an increment or decrement signal from one of the plurality of vibration sensor units whenever the one of the plurality of vibration sensors determines that an occupant has entered or exited the zone. In some embodiments, the plurality of vibration sensor units all communicate to a central controller. In some embodiments, the central controller is a hub for the vibration sensors. The central controller can be a thermostat, a building controller, a lighting system controller, a VAV controller, a VRF controller, and/or any other type of controller or computing system.

### Building Automation System and HVAC System

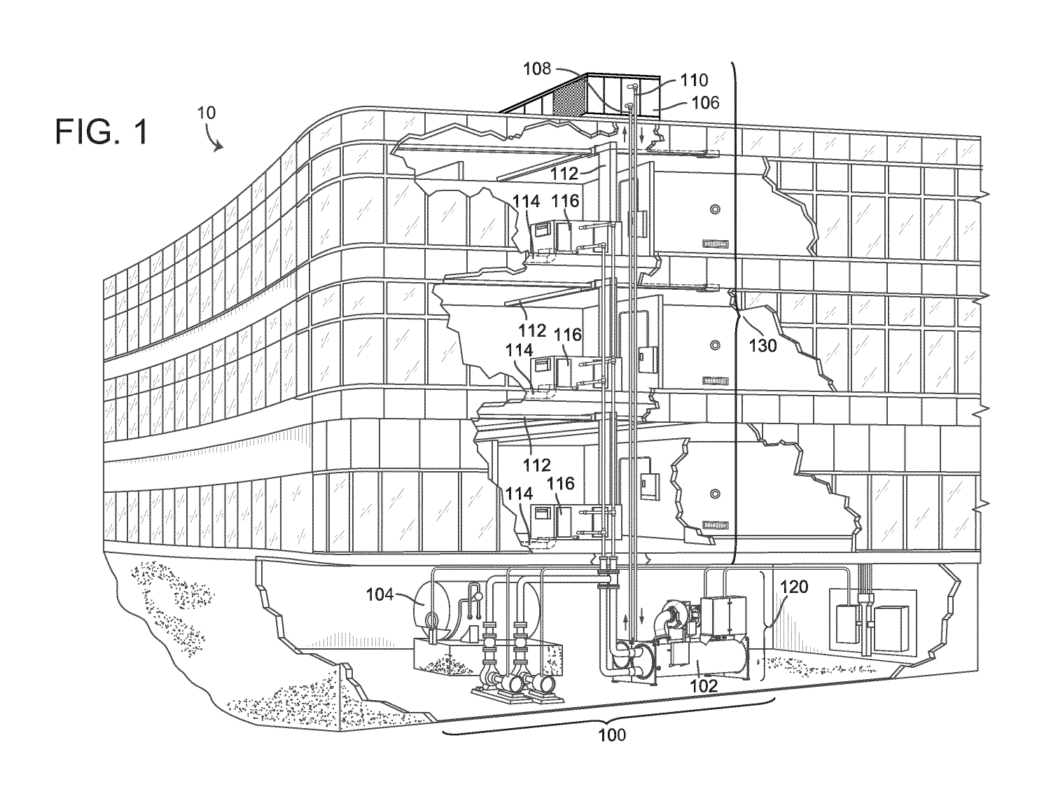

Referring now to FIGS. 1-4, an exemplary building automation system (BAS) and HVAC system in which the systems and methods of the present invention can be implemented are shown, according to an exemplary embodiment. Referring particularly to FIG. 1, a perspective view of a building 10 is shown. Building 10 is served by a BAS. A BAS is, in general, a system of devices configured to control, monitor, and manage equipment in or around a building or building area. A BAS can include, for example, a HVAC system, a security system, a lighting system, a fire alarming system, any other system that is capable of managing building functions or devices, or any combination thereof.

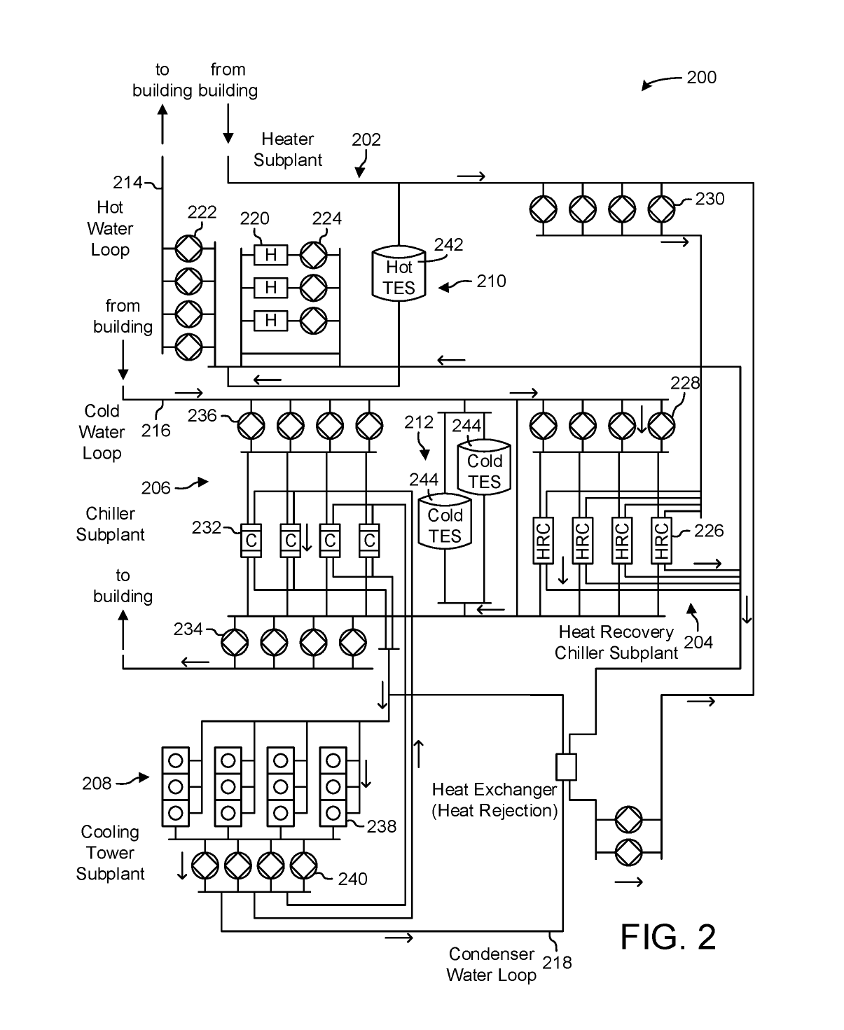

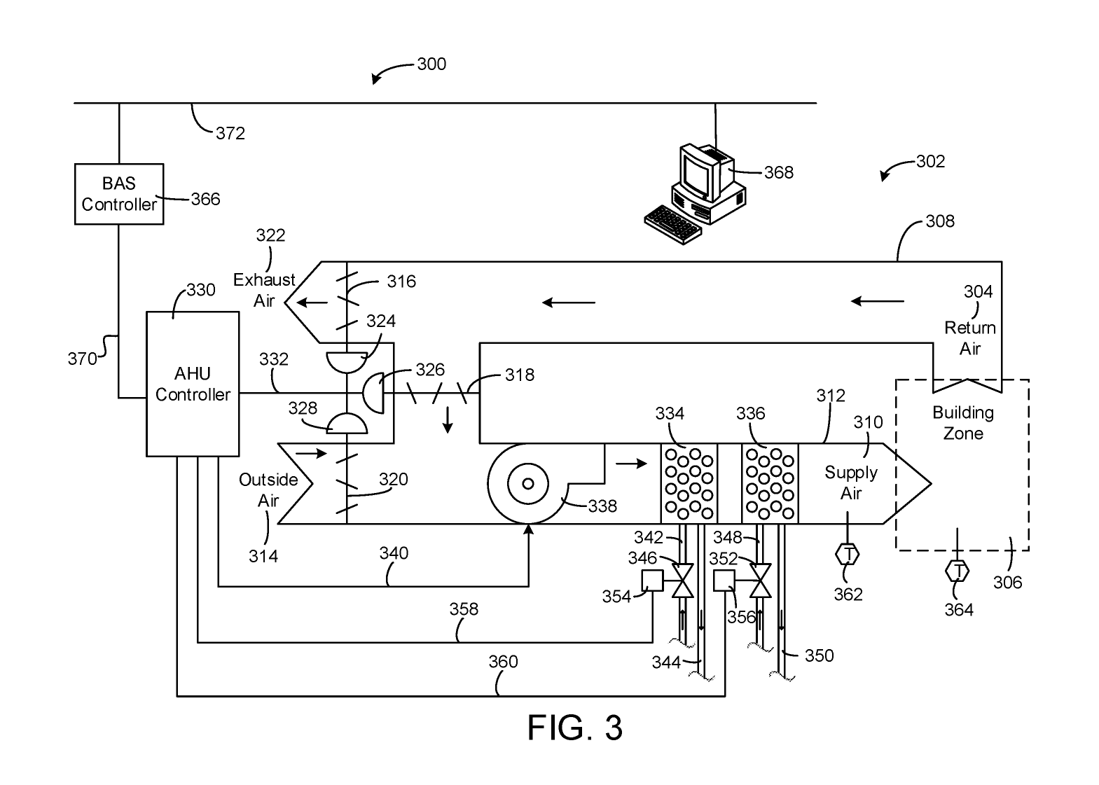

The BAS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 and building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BAS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BAS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building automation system (BAS) controller 366 and a client device 368. BAS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BAS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BAS controller 366 can be separate (as shown in FIG. 3) or integrated. In an integrated implementation, AHU controller 330 can be a software module configured for execution by a processor of BAS controller 366.

In some embodiments, AHU controller 330 receives information from BAS controller 366 (e.g., commands, setpoints, operating boundaries, etc.) and provides information to BAS controller 366 (e.g., temperature measurements, valve or actuator positions, operating statuses, diagnostics, etc.). For example, AHU controller 330 can provide BAS controller 366 with temperature measurements from temperature sensors 362-364, equipment on/off states, equipment operating capacities, and/or any other information that can be used by BAS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BAS controller 366 and/or AHU controller 330 via communications link 372.

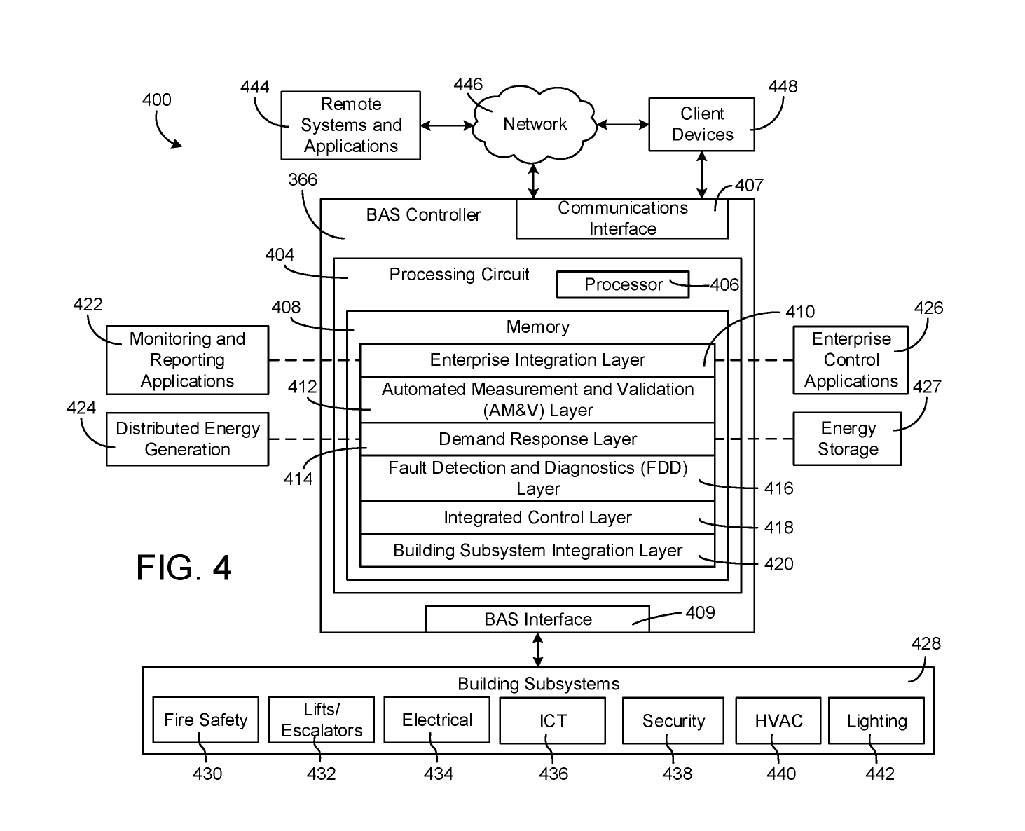

Referring now to FIG. 4, a block diagram of a building automation system (BAS) 400 is shown, according to an exemplary embodiment. BAS 400 can be implemented in building 10 to automatically monitor and control various building functions. BAS 400 is shown to include BAS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BAS controller 366 is shown to include a communications interface 407 and a BAS interface 409. Interface 407 can facilitate communications between BAS controller 366 and external applications (e.g., monitoring and reporting applications 422, enterprise control applications 426, remote systems and applications 444, applications residing on client devices 448, etc.) for allowing user control, monitoring, and adjustment to BAS controller 366 and/or subsystems 428. Interface 407 can also facilitate communications between BAS controller 366 and client devices 448. BAS interface 409 can facilitate communications between BAS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 366 is shown to include a processing circuit 404 including a processor 406 and memory 408. Processing circuit 404 can be communicably connected to BAS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 366 is implemented within a single computer (e.g., one server, one housing, etc.). In various other embodiments BAS controller 366 can be distributed across multiple servers or computers (e.g., that can exist in distributed locations). Further, while FIG. 4 shows applications 422 and 426 as existing outside of BAS controller 366, in some embodiments, applications 422 and 426 can be hosted within BAS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BAS controller 366. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 can be configured to manage communications between BAS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BAS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML, files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration can reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BAS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BAS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alarm a user to repair the fault before it becomes more severe.

### Vibration Sensor Systems

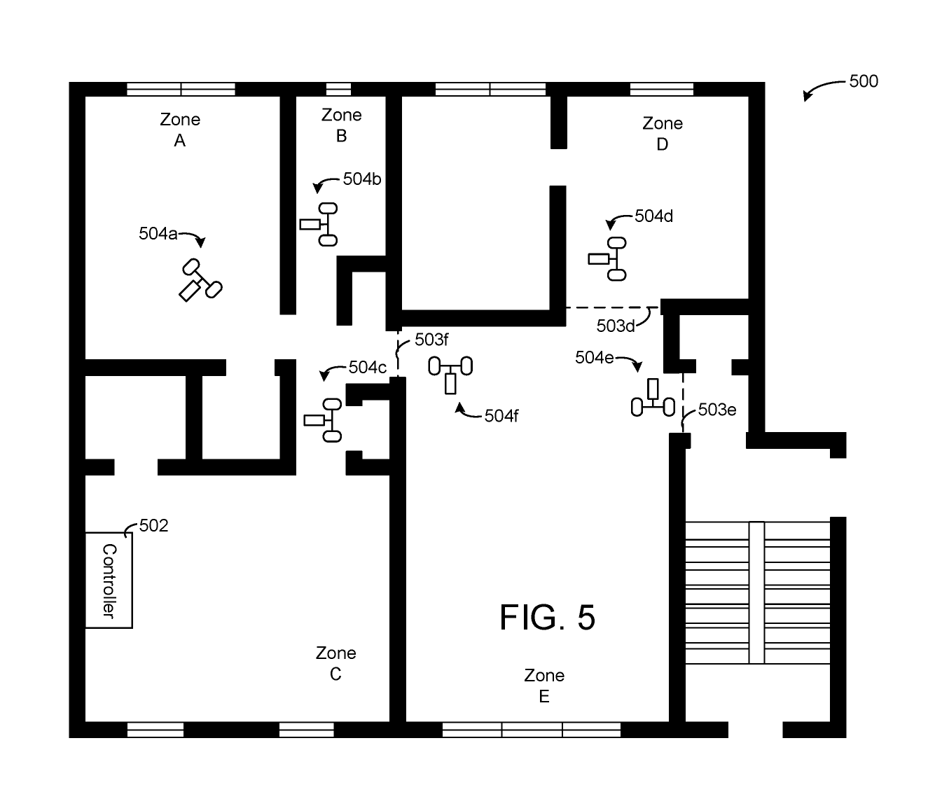

Referring now to FIG. 5, a block diagram of a building system with vibration sensor units is shown, according to an exemplary embodiment. In FIG. 5, a particular floor 500 of building 10, as described with reference to FIG. 1, is shown. Floor 500 is shown to be divided into a plurality of zones, i.e., Zone A, Zone B, Zone C, Zone D, and Zone E. In FIG. 5, the zones are shown to be individual rooms of floor 500. However, it should be understood that zones may be particular groups of rooms (e.g., all rooms on the north side of floor 500, all rooms on the south side of floor 500, offices, storage areas, etc.). Further, in various embodiments, each zone can be a particular floor or floors of building 10.

In FIG. 5, a plurality of vibration sensor units 504a-f are shown located in and around each of the zones. Each of vibration sensor units 504a-f can be configured to detect the movement of an occupant. Further, each of vibration sensor units 504a-f can be configured to detect the direction an occupant is traveling. In FIG. 5, each of vibration sensor units 504a-f are located in an entry or exit point of floor 500 and zones A-E. Since each vibration sensor is located at an entry or exit point, each of vibration sensor units 504a-f can be configured to determine if an occupant is entering a zone or exiting a zone.

In some embodiments, vibration sensor units 504a-f are located under the floor at a door frame. The door frame may mark an entry or exit point of a zone. Vibration sensor units 504a-f can be configured to be located under the floor at each entry or exit point of floor 500. In this regard, vibration sensor units 504a-f can be configured to detect movements by an occupant but remain unseen by the occupant and never directly touched by an occupant. In various embodiments, vibration sensor units 504a-f can be located on a door frame, a wall, under a carpet, on a ceiling, and/or in any other location by and/or at an entry of exit point of floor 500.

FIG. 5 is shown to include controller 502. Controller 502 can be any kind of building controller such as a thermostat, an equipment controller for controlling HVAC equipment (e.g., a smart actuator, a controller for a variable refrigerant flow (VRF) device, a controller for a VAV unit, etc.), BAS controller 366 as described with reference to FIG. 4, a server, a laptop computer, a desktop computer, and/or any other kind of computing device. In some embodiments, controller 502 is a cloud service, i.e., a functionality offered by a cloud server.

Controller 502 can be configured to communicate with vibration sensor units 504a-f and likewise, vibration sensor units 504a-f can be configured to communicate with controller 502. In some embodiments, vibration sensor units 504a-f are configured to communicate among themselves. In various embodiments, vibration sensor units 504a-f and/or controller 502 can be configured to communicate via a network, e.g., a Local Area Network (LAN), a Wide Area Network (WAN) (e.g., the Internet), and/or a Metropolitan Area Network (MAN). In this regard, building 10 and/or floor 500 may include one or more network routers, network switches, and/or any other infrastructure necessary for facilitating a network. In some embodiments, controller 502 and vibration sensor units 504a-f are configured to communicate via Zigbee, Wi-Fi, LoRa, Bluetooth (e.g., Bluetooth Low Energy), WiMax, and/or any other type of wireless communication. In some embodiments, vibration sensor units 504a-f and/or controller 502 communicate via RS-485, RS-232, Ethernet cables, direct signal wiring, and/or any other wired means of communication. In various embodiments, controller 502 and vibration sensors 504a-f can be configured to communicate via protocols such as Master Slave Token Passing (MSTP), Controller Area Network (CAN bus), Building Automation and Control Network (BACnet), Modbus, and/or any other protocol.

In various embodiments, controller 502 and vibration sensors 504a-f can be configured to communicate information to determine (e.g., count) the number of occupants in zones A-E by counting the number of occupants that enter or exit the zones. Vibration sensors 504a-f can be configured to individually determine whether an occupant is entering or exiting a zone and/or communicate with other vibration sensor 504a-f to determine the number of occupants in the zone. Vibration sensor units 504a-f can be configured to send an indication that they have detected an occupant entering or exiting a zone to controller 502. Based on the entering and exiting information received from vibration sensor units 504a-f, controller 502 can be configured to determine the number of occupants in each of zones A-E and can be configured to make equipment control decisions based on the determined number of occupants in each of zones A-E.

The following is an example of three vibration sensor units communicating to a controller to determine the occupancy of a particular zone. In Zone E, there are three entry and exit points, entry/exit point 503f, entry/exit point 503d, and entry/exit point 503e. At each entry or exit point, a vibration sensor unit is placed. For Zone E, vibration sensor unit 504d is located at entry/exit point 503d, vibration sensor unit 504e is located at entry/exit point 503e, and vibration sensor unit 504f is located at entry/exit point 503f Each of vibration sensor units 504d, 504e, 504f can communicate information to controller 502 indicative of an occupant entering or exiting zone E via entry/exit point 503f, entry/exit point 503d, and entry/exit point 503e. Any time controller 502 receives information of an occupant entering Zone E, controller 502 may increment a running total number of occupants in Zone E. Whenever controller 502 receives information of an occupant exiting Zone E, controller may decrement the running total number. Controller 502 can be configured to simultaneous keep running totals for each of Zones A-E.

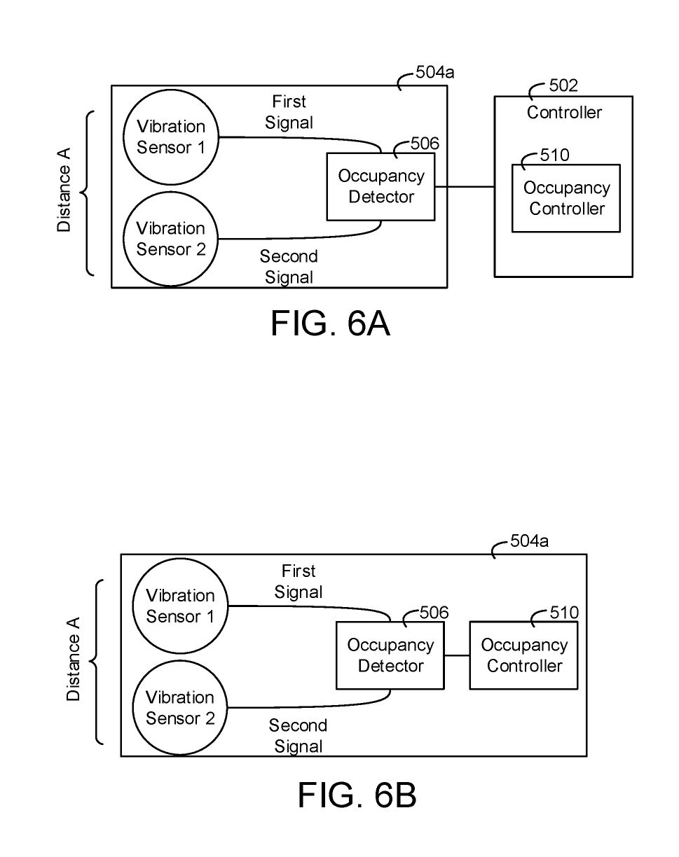

Referring generally to FIGS. 6A and 6B, embodiments of vibration sensor 504a are shown, according to various exemplary embodiments. Vibration sensor 504a is shown as a representative of vibration sensors 504a-f. It should be understood that the description of vibration sensor 504a herein can be applied to vibration sensors 504b-f. In FIGS. 6A-6B, vibration sensor 1 and vibration sensor 2 are shown. Vibration sensor 1 and vibration sensor 2 may be vibration sensors that are configured to detect vibrations. Vibration sensor 1 and vibration sensor 2 may be an accelerometer. In some embodiments, vibration sensors 1 and 2 are piezoelectric vibration sensors. Vibration sensors 1 and 2 can be any type of sensor configured to measure vibrations.

Referring more particularly to FIG. 6A, vibration sensor 504a is shown in greater detail, according to an exemplary embodiment. Vibration sensor 504a is shown to include vibration sensor 1 and vibration sensor 2. Vibration sensor 1 and vibration sensor 2 are shown to be located a predefined distance apart (e.g., a predefined distance from the center of each vibration sensor), i.e., distance A. Distance A may be on the range of inches (e.g., 1 inch-11 inches) or on the range of tenths of an inch (e.g., if vibration sensor 1 and 2 are located immediately next to each other) or on the range of feet (e.g., 1-10 feet). Vibration sensor 1 and vibration sensor 2 are shown to be connected to occupancy detector 506. Occupancy detector 506 can include a processing circuit and/or software run on a processing circuit that is configured to determine occupancy based on vibration signals received from vibration sensor 1 and vibration sensor 2.

Occupancy detector 506 can be configured to receive vibration signals from vibration sensor 1 and vibration sensor 2. These vibration signals may be generated by vibration sensors 1 and 2 based on movement (e.g., walking, running, crawling, etc.) of an occupant. The vibration signals may be digital signals (e.g., discrete samples) or analog signals (e.g., continuous signals). Based on the vibration signals, occupancy detector 506 can determine if an occupant is entering a zone or exiting a zone. The entry or exit information determined by occupancy detector 506 can be sent to controller 502, i.e., occupancy detector 506 can be configured to communicate the entry or exit information to controller 502. Controller 502 is shown to include occupancy controller 510. Occupancy controller 510 can include a processing circuit and/or software run on a processing circuit.

Occupancy controller 510 can be configured to receive information indicating entry or exit of a zone from vibration sensor unit 504a. In this regard, occupancy controller 510 can be configured to determine the number of occupants in a particular zone. The embodiment of FIG. 6A may be applicable for zones where there are multiple entry and exit points. In this regard, controller 502 may communicate to a plurality of vibration sensor units and may use the entry or exit information received form the plurality of vibration sensor units to determine the total number of occupants in a zone. In some embodiments, there may be a single “master” occupancy sensor unit. The master occupancy sensor unit can receive occupancy information from other occupancy sensor units that are associated with the same zone as the master occupancy sensor unit. The master occupancy sensor unit can be configured to determine the total occupancy for the zone it is associated based on the occupancy information that it receives from the other occupancy sensors and based on any occupancy determinations it makes via its own vibration sensors.

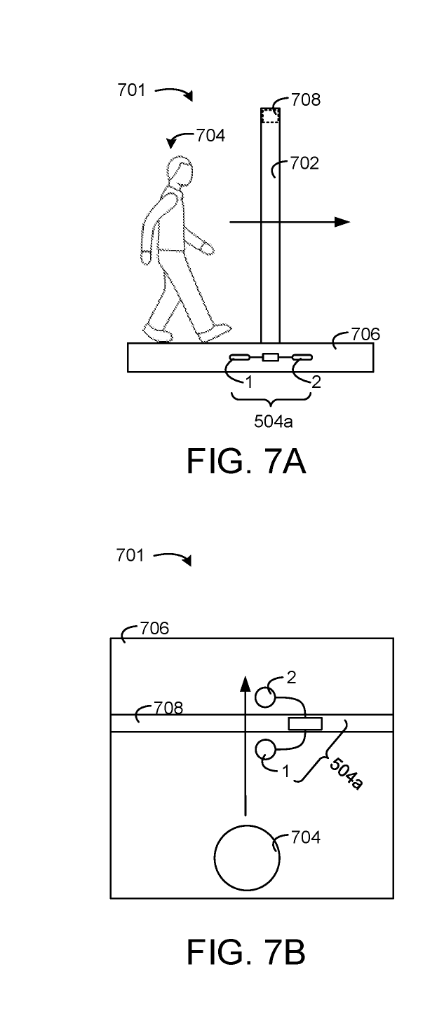

Referring now to FIG. 6B, vibration sensor unit 504a is shown to include occupancy controller 510, according to an exemplary embodiment. In FIG. 7A, vibration sensor unit 504a can be configured to determine if an occupant is entering or exiting a zone via occupancy detector 506 and can further be configured to determine the total number of occupants in a zone. The embodiment of FIG. 7A may be applicable for a zone with a single entry of exit point since a single occupancy sensor unit can be configured to determine if an occupant has entered or exited the zone and further determine the total number of occupants in the zone.

Referring now to FIG. 7A, a diagram 701 of an occupant 704 being detected by vibration sensor unit 504a is shown from a side view, according to an exemplary embodiment. Vibration sensor unit 504a is shown to be located under floor 706 that occupant 704 walks on. In various embodiments, vibration sensor unit 504a is located on top of floor 706 or within floor 706. In this regard, the first signal and the second signal that vibration sensors 1 and 2 determine may be vibration sensor created by occupant 704 by walking or otherwise moving on floor 706. Vibration sensors 1 and 2 can detect the vibration of occupant 704 walking by sensing the vibration in floor 706. In FIG. 7A, vibration sensor 504a (specifically vibrations sensors 1 and 2) is shown to be located substantially parallel to the direction of movement of occupant 704. In various embodiments, the plane of movement of occupant 704 is parallel to the plane that vibration sensor unit 504a is located on. Vibration sensor unit 504a is shown to be located under door frame 702. Further, vibration sensor unit 504a is shown to be located substantially perpendicular to head board 708 of door frame 702. The plane that vibration sensor unit 504a is located on may be substantially orthogonal to the vertical plane that door frame 702 is located on.

Referring now to FIG. 7B, diagram 701 of occupant 704 being detected by vibration sensor unit 504a is shown from a top view. As can be seen in FIG. 7B, occupant 704 is located closer to vibration sensor 1 than vibration sensor 2. Since vibration sensor 1 is located closer to occupant 704 than vibration sensor 2 as occupant 704 crosses door frame 702 (e.g., exits or enters a zone), the signal that vibration sensor 1 senses may have a higher magnitude that the signal determined by vibration sensor 2. Further, there may be a time shift between the first and second signals since vibration sensor 1 is located closer to occupant 704 than vibration sensor 2. In FIG. 7B, based on the direction of movement indicated by the arrow, the second signal generated by vibration sensor 1 may lead the first signal generated by vibration sensor 2 (i.e., there may be a positive time offset between the second signal and the first signal).

If occupant 704 traveled in the opposite direction, i.e., was closer to vibration sensor 1 than vibration sensor 2, the magnitude of vibration detected by sensor 1 may be higher than the magnitude of vibration detected by sensor 2. Further, the signal from sensor 1 may lead the signal from sensor 2 (i.e., there may be a negative offset between the second signal and the first signal). Vibration sensor unit 504a and/or vibration sensors 1 and 2 may be positioned in such a way that vibration sensor 1 is located closer to occupant 704 as compared to vibration sensor 2 as occupant 704 enters a zone and vice versa when occupant 704 exits the zone. For example, vibration sensor 1 is located on one side of door frame 702 and vibration sensor 2 is located on a second side of door frame 702.

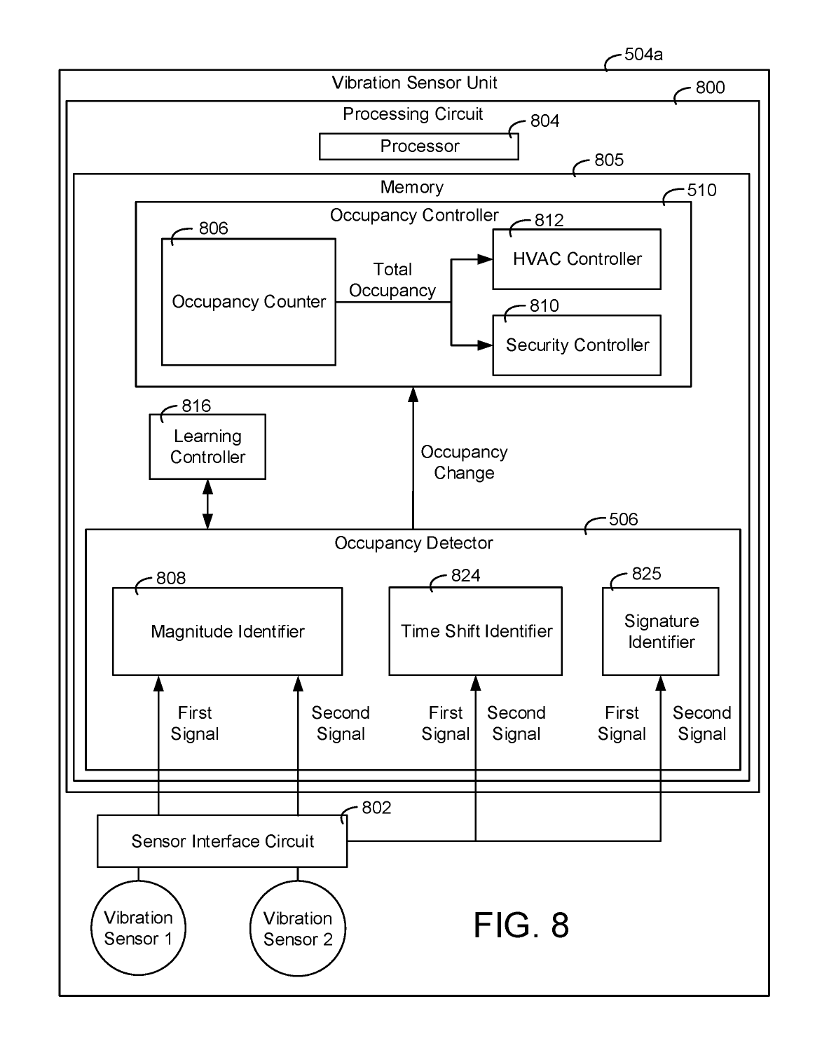

Referring now to FIG. 8, vibration sensor unit 504a is shown in greater detail, according to an exemplary embodiment. In FIG. 8, vibration sensor unit 504a is shown to include processing circuit 800 and sensor interface circuit 802. Sensor interface circuit 802 can be configured to receive signals from vibration sensor 1 and vibration sensor 2 and provide the signals to processing circuit 800. Sensor interface circuit 802 may include one or more signal amplifier circuits, filters (e.g., low pass, high pass, bandpass, notch), and/or any other circuit necessary for pre-processing the signals received from vibration sensor 1 and vibration sensor 2. In some embodiments, sensor interface circuit 802 includes an analog to digital converter (ADC). In some embodiments, sensor interface circuit 802 is a component of processing circuit 800 and is an ADC for processing circuit 800.

Processing circuit 800 is shown to include a processor 804 and memory 805. Processor 804 can be a general purpose or specific purpose processor, an application specific integrated circuit (ASIC), one or more field programmable gate arrays (FPGAs), a group of processing components, or other suitable processing components. Processor 804 may be configured to execute computer code and/or instructions stored in memory 406 or received from other computer readable media (e.g., CDROM, network storage, a remote server, etc.).

Memory 805 can include one or more devices (e.g., memory units, memory devices, storage devices, etc.) for storing data and/or computer code for completing and/or facilitating the various processes described in the present disclosure. Memory 805 can include random access memory (RAM), read-only memory (ROM), hard drive storage, temporary storage, non-volatile memory, flash memory, optical memory, or any other suitable memory for storing software objects and/or computer instructions. Memory 805 can include database components, object code components, script components, or any other type of information structure for supporting the various activities and information structures described in the present disclosure. Memory 805 can be communicably connected to processor 804 via processing circuit 800 and can include computer code for executing (e.g., by processor 804) one or more processes described herein.

Memory 805 is shown to include occupancy detector 506. Occupancy detector 506 is shown to include magnitude identifier 808. Magnitude identifier 808 is configured to receive signals from vibration sensor 1 and vibration sensor 2, i.e., a first signal and a second signal. Magnitude identifier 808 can be configured to identify the magnitudes of the first single and the second signal. Magnitude identifier 808 can be configured to provide the identified magnitudes to occupancy detector 506 so that occupancy detector 506 can identify changes in occupancy based on the magnitudes of the first signal and the second signal. In some embodiments, magnitude identifier 808 can determine if the an average magnitude, a moving average, a maximum, etc.

Occupancy detector 506 is shown to include time shift identifier 824. Time shift identifier 824 can be configured to compare first signal and second signal to determine a time shift between the two signals. In some embodiments, the first signal the second signal are similar and/or identical. In this regard, time shift identifier 824 can be configured to compare the similar and/or identical signals to determine a shift between the two signals. In some embodiments, time shift identifier 824 identifies a time (e.g., seconds, milliseconds, microseconds, pico-seconds) that is indicative of the amount of time that the first or second signal leads. In some embodiments, time shift identifier 824 identifies a phase between the first signal and the second signal.

Occupancy detector 506 is shown to include signature identifier 825. Signature identifier 825 can be configured to determine, based on the first signal and the second signal, whether one or more occupants are entering or exiting a zone and/or whether the first and second signals indicate a human, an animal, or a wheelchair is entering or exiting the zone. In some embodiments, signature identifier 825 can determine the type of movement of an occupant (e.g., running, walking, crawling). In some embodiments, signature identifier 825 can be configured to determine how many occupants are entering a zone and how many occupants are exiting a zone when some occupants enter a zone and some occupants simultaneously exit a zone. Signature identifier 825 can include a filter bank. The filter bank may include a plurality of digital filters with particular weights. Signature identifier 825 can be configured to use the filter bank and the first and second signal to identify the number of occupants entering or exiting at a given time, the identity of an occupant (e.g., dog, cat, human, person in wheelchair, etc.). Signature identifier 825 can be configured to generate a signature which may include frequency harmonics of the first and/or second signal, magnitude differences between the first and second signal, and/or a time shift between the first and second signal. This signature can be used by signature identifier 825 to classify an occupant as a human, an adult, a child, a person in a wheelchair, a cat, a dog, and/or any other entity.

Occupancy detector 506 can be configured to determine changes in occupancy based on the magnitudes of the first and second signals, the time shift between the first and second signals, and/or a signature identified by signature identifier 825. In some embodiments, occupancy detector 506 can be configured to compare the magnitude and/or time shift of the first signal and second signals over time to determine whether an occupant has entered a zone or exited a zone. For example, in some embodiments, occupancy detector 506 can determine if a differential magnitude of the magnitudes identified by magnitude identifier 808 first sensor and the second sensor changes from positive to negative over time. This may indicate that an occupant has walked across vibration sensors 1 and 2. This may indicate that an occupant is entering a zone. If the differential magnitude switches from negative to positive over time, it may indicate that, an occupant is leaving the zone.

Whether an occupant is entering or exiting a zone may be based on the orientation of vibration sensor unit 504a. For this reason, vibration sensor unit 504a may be positioned a particular way in a zone. For example, vibration sensor 1 may be located on one side of a door (e.g., on the outside of a zone) while vibration sensor 2 may be located on the other side of the door.

In some embodiments, occupancy detector 506 can be configured to determine if an occupant is entering or exiting a zone based on a time shift between the first signal and the second signal. In some embodiments, if the first signal is leading the second signal, as determined by time shift identifier 824, occupancy detector 506 can determine that an occupant is entering a zone. Similarly, if the second signal is leading the first signal, as determined by time shift identifier 824, time shift identifier 824 can determine that the occupant is leaving the zone. In some embodiments, whether the first or second signal leads indicates an occupant entering a zone or exiting a zone. In some embodiments, learning controller 816 indicates a time shift that indicates an occupant entering a zone or exiting a zone.

Learning controller 816 can be configured to gather information in a “learning” period. Learning controller 816 can determine calibration data based on the first and second signals during the learning period. In some embodiments, learning controller 816 can be configured to facilitate the gathering of data that can be used by occupancy detector 506 to determine whether occupants are entering or exiting a zone. In some embodiments, a user indicates to vibration sensor unit 504a, to perform a learning process by pressing a physical button or switch on vibration sensor unit 504a, pressing a virtual button on a user interface of a device connected to vibration sensor unit 504a, and/or any other method for causing vibration sensor 504a to enter a learning period. Vibration sensor unit can determine if the magnitude of the first signal is greater than the second signal as an occupant is entering a zone. The magnitudes may indicate which direction of travel the occupant should travel.

In some embodiments, when in the learning period, a user enters or exits a zone a predefined amount of times. During these entry and exits of the zone, learning controller 816 can be configured to identify time shifts between the first and second signals that indicate occupants entering or exiting the zone. Further, learning controller 816 can be configured to determine magnitude comparisons between first signal and second signal that indicate an occupant entering or exiting a zone. Further, learning controller 816 can be configured to calibrate weights for the filter bank of signature identifier 825 as the occupants enters or exits the zone.

The data gathered by learning controller 816 may be weights for a filter bank of occupancy detector 506 or other calibration data necessary for occupancy detector 506 to accurately determine occupancy. Various environments may have different characteristics that affect the accurate determination of occupancy changes. For example, furniture in a zone, size of a zone, type of carpeting, flooring, etc. can all be taken into account by collecting calibration data.

Occupancy detector 506 can be configured to determine a change in occupancy. The change in occupancy may indicate number of occupants entering a zone, number of occupants exiting a zone, and/or a net addition of occupants to a zone. The occupancy change determined by occupancy detector 506 can be provided to occupancy controller 510. Occupancy controller 510 can be configured to determine, based on the occupancy change determined by occupancy detector 506, the number of occupants in a zone.

Occupancy controller 510 can include occupancy counter 806. Occupancy counter 806 can be configured to identify a total number of occupants in a particular zone. Any time the occupancy changes, as identified by occupancy detector 506, occupancy counter 806 can increment and/or decrement a total occupancy that it stores. This total occupancy may indicate the number of occupants in the particular zone. Occupancy counter 806 can be configured to provide the total occupancy of the zone it determines to HVAC controller 812 and security controller 810.

HVAC controller 812 can be configure to controller HVAC equipment to control an environmental conditions of a zone based on the total occupancy of the zone as identified by occupancy counter 806. Further, HVAC controller 812 can be connected to audio systems, lighting systems, and/or any other system that can be controlled based on occupancy. In some embodiments, HVAC controller 812 uses model predictive control, PID loops, PI loops, P controllers, and or any other method for controlling HVAC equipment. HVAC controller 812 can be configured to cause a zone to meet a setpoint. In some embodiments, based on the number of occupants in the zone, HVAC controller 812 can be configured to cause the zone to be at a particular temperature. For example, if there are few or no occupants in a zone, HVAC controller 812 may cause HVAC equipment to stop operating.

If HVAC controller determines there are one or more occupants in a zone, HVAC controller 812 can be configured to cause the HVAC equipment to operate to achieve a particular temperature. HVAC controller 812 can be configured to perform occupancy based control such as the control described in U.S. patent application Ser. No. 09/409,960 (now U.S. Pat. No. 6,296,193) filed Sep. 30, 1999 and U.S. patent application Ser. No. 12/819,977 (now U.S. Pat. No. 8,600,556) filed Jun. 21, 2010, the entireties of which are incorporated by reference herein.

HVAC controller 812 may determine a load for a zone based on the total occupancy. In some embodiments, the load for the zone is proportional to the total occupancy and/or the size of the zone. HVAC controller 812 can be configured to store the size of the zone. Based on the load of the zone, HVAC controller 812 can be configured to generated control signals for equipment (e.g., HVAC equipment) associated with the zone. For example, if there is a high load during hot summer days, HVAC controller 812 may continuously run HVAC equipment, even after reaching a setpoint temperature. For winter days, HVAC controller 812 can run the equipment less for a high load since the high number of occupants may be generating heat.

Security controller 810 can be configured to notify security personal of the occupancy in particular zones in the event of an emergency (e.g., an evacuation of building 10). Security controller 810 can be configured to send a notification to a security system (e.g., an emergency system of 911, a fire department system, a police system, etc.) that indicates if any occupants are in a zone based on the total occupancy received from occupancy counter 806. In some embodiments, security controller 810 may act as a silent alarm and notify a security system of an intruder if one of vibration sensor units 504a detects an occupant during a particular time period (e.g., between 1:00 A.M. and 4:00 A.M.) or during certain operating conditions (e.g., the building is closed or locked). This same functionality can be performed by controller 502 (e.g., by emergency controller 924).

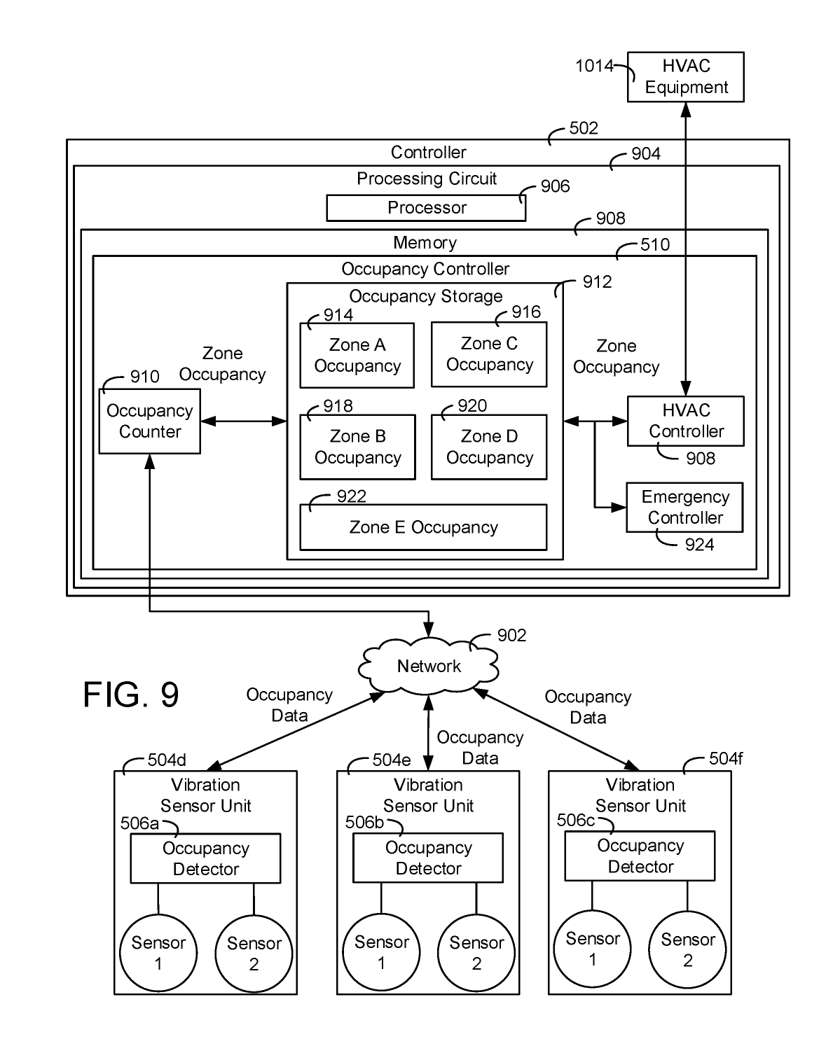

Referring now to FIG. 9, a system of a plurality of vibration sensor units 504d-f communicating to controller 502 is shown, according to an exemplary embodiment. Although three vibration sensor units are shown communicating to controller 502 in FIG. 9, any number of vibration sensor units can be configured to communicate to controller 502.

In FIG. 9, vibration sensor units 504d-f are shown to communicate occupancy data to controller 502 via network 902. Network 902 can be a LAN, a WAN (e.g., the Internet), and/or a MAN. Network 902 can be Zigbee, Wi-Fi, LoRa, Bluetooth (e.g., Bluetooth Low Energy), WiMax, and/or any other type of wireless communication known in the art or described herein. Network 902 can further be RS-485, RS-232, Ethernet Cables, direct signal wiring, and/or any other wired means of communication. Controller 502 can be configured to receive occupancy data from vibration sensor units 504d-f via network 902.

Controller 502 is shown to include processing circuit 904. Processing circuit 904 is shown to include a processor 906 and memory 908. Processor 906 can be a general purpose or specific purpose processor, an application specific integrated circuit (ASIC), one or more field programmable gate arrays (FPGAs), a group of processing components, or other suitable processing components. Processor 906 may be configured to execute computer code and/or instructions stored in memory 908 or received from other computer readable media (e.g., CDROM, network storage, a remote server, etc.).

Memory 908 can include one or more devices (e.g., memory units, memory devices, storage devices, etc.) for storing data and/or computer code for completing and/or facilitating the various processes described in the present disclosure. Memory 908 can include random access memory (RAM), read-only memory (ROM), hard drive storage, temporary storage, non-volatile memory, flash memory, optical memory, or any other suitable memory for storing software objects and/or computer instructions. Memory 908 can include database components, object code components, script components, or any other type of information structure for supporting the various activities and information structures described in the present disclosure. Memory 908 can be communicably connected to processor 906 via processing circuit 904 and can include computer code for executing (e.g., by processor 906) one or more processes described herein.

Memory 908 is shown to include occupancy counter 910. Occupancy counter 910 may receive the occupancy data from vibration sensor units 504d-f and determine zone occupancy. In some embodiments, the occupancy data indicates one or more occupants entering a zone or exiting a zone. Based on this information, occupancy counter 910 can determine the number of occupants in a zone. In some embodiments, occupancy counter 910 stores a plurality of associations between vibration sensor units (e.g., vibration sensor units 504d-f) and a particular zone which the vibration sensor units are associated with. Based on these associations, occupancy counter 910 can determine how to attribute occupancy data to a particular zone.

For example, with reference to FIG. 5, vibration sensor unit 504d may have a relationship with zone D and zone E. For this reason, based on occupancy data received by occupancy counter 910, occupancy counter 910 can increment or decrement the occupancy of zones D and E based on the occupancy data that vibration sensor unit 504d sends to occupancy counter 910. If the occupancy data of vibration sensor unit 504d indicates that an occupant has left zone D and has entered zone E, occupancy counter can increment the occupancy of zone E by one and decrement the occupancy of zone D by one.

In this regard, the occupancy for a particular zone, as determined by occupancy counter 910, can be determined based on the occupancy data received from one or more vibration sensor units that are associated with the zone. For zone E, the occupancy of zone E as determined by occupancy counter 910 may be dependent on vibration sensor units 504d-f. For zone D, the occupancy may be based on the occupancy data of only vibration sensor unit D. For zone A, the occupancy may be based on only the occupancy data received from zone A.

With reference to FIG. 9, occupancy storage 912 can be configured to store the occupancy for one or more zones of a building. Zone A occupancy 914, zone C occupancy 916, zone B occupancy 918, zone D occupancy 920, and zone E occupancy 922 can be configured to store the occupancy count for zones A, B, C, D, and E respectively, as described with reference to FIG. 5. Occupancy counter 910 can be configured to increment or decrement the occupancy stored by occupancy storage 912 so that the occupancy stored by occupancy storage 912 reflects the occupancy as indicated by the occupancy data received by occupancy counter 910.

HVAC controller 924 can be configured to use the occupancy stored by occupancy storage 912 to control HVAC equipment 1014 which may control the ambient conditions in one or more zones. HVAC controller 924 can be configured to generate control signals for HVAC equipment 1014 based on the occupancy. In various embodiments, HVAC controller 924 can be configured to send occupancy data (e.g., the occupancy of a zone) to another controller that controls the environmental conditions of the zone.

Emergency controller 1016 can be configured to communicate with various emergency systems. Emergency controller 1016 can be the same and/or similar to security controller 810 as described with reference to FIG. 8. For example, in the event that there is an emergency in building 10 such as a fire, flooding, a tornado, an active shooter, etc., emergency controller 1016 can be configured to send occupancy information for various zones to an emergency system (e.g., a computer system or server operated by the fire department, police department, etc.). Emergency personal can use the occupancy of the various zones to make sure everyone has properly evacuated the building and know where to search for individuals who may be trapped in building 10.

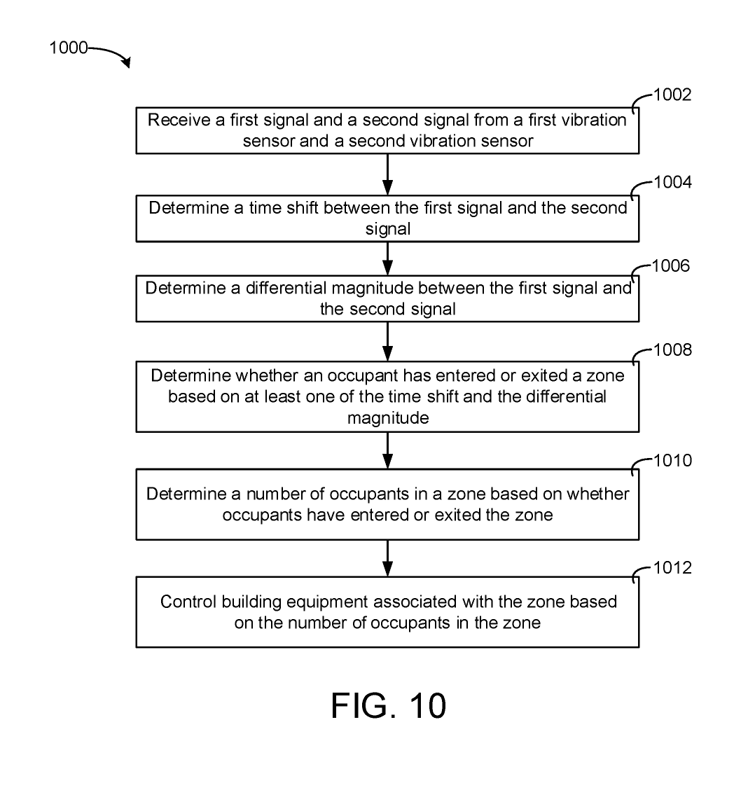

Referring now to FIG. 10, a process 1000 for determining a number of occupants in a zone with a vibration sensor unit (e.g., vibration sensor unit 504a) is shown, according to an exemplary embodiment. Process 1000 is described with reference vibration sensor unit 504a, and thus, vibration sensor unit 504a can be configured to perform process 1000. However, any of the vibration sensors described herein and/or any other computing device can be configured to perform process 1000.

In step 1002, occupancy detector 506 can be configured to receive a first signal and a second signal from a vibration sensor 1 and vibration sensor 2. The first signal and the second signal may be generated by vibration sensor 1 and vibration sensor 2 based on the movement (e.g., walking) of an occupant entering or exiting a zone.

In step 1004, time shift identifier 824 can determine a time shift between the first signal and the second signal. In some embodiments, the occupant is closer to the first vibration sensor as compared to the second vibration sensor as the occupant enters the zone and closer to the second vibration sensor as compared to the first vibration sensor as the occupant exits the zone. For this reason, there may be a time shift between the first and second signals that time shift identifier 824 can identify. In some embodiments, time shift identifier 824 can monitor the time shift over time and determine how the time shift changes over time.

In step 1006, magnitude identifier 808 can be configured to determine a differential magnitude between the first signal and the second signal. In some embodiments, the differential magnitude is the difference in magnitude between the first vibration sensor and the second vibration sensor. In some embodiments, the differential magnitude is the difference in a moving average magnitude between the first vibration sensor and the second vibration sensor.

In step 1008, occupancy detector 506 can be configured to determine whether an occupant is entering or exiting the zone. Occupancy detector 506 can be configured to use the differential magnitude determined in step 1006 and/or the time shift determined in step 1004 to determine whether the occupant is entering or exiting the zone. In some embodiments, occupancy detector 506 can determine that an occupant is entering or exiting the zone based on whether the time shift between the first and second signals is positive or negative. Positive may indicate that the occupant is entering the zone while negative may indicate that the occupant is exiting the zone. Further, occupancy detector 506 can be configured to determine that the occupant is entering the zone if the magnitude of the first signal is greater than the second signal. If the magnitude of the second signal is greater than the first signal, occupancy detector 506 can determine that the occupant is exiting the zone.

In step 1010, occupancy counter 806 can be configured to determine a total occupancy of the zone based on the determination of step 1008. In some embodiments, occupancy counter 806 keeps a running total of the number of occupants in the zone. In some embodiments, occupancy counter 806 increments the total occupancy in response to determining, in step 1008, that the occupant has entered the zone and can decrement the total occupancy in response to determining in step 1008 that an occupant has exited the zone.

In step 1012, building equipment can be controlled by vibration sensor unit 504a based on the total occupancy determined in step 1010. In some embodiments, vibration sensor unit 504a can control HVAC equipment and/or systems, lighting equipment and/or systems, security equipment and/or systems, fire equipment and/or systems, any emergency equipment and/or systems and any other equipment and/or system described herein based on the total occupancy determined in step 1010. In some embodiments, HVAC controller 812 can control equipment based on the total occupancy determined in step 1010. In some embodiments, HVAC controller 812 may control lighting equipment, HVAC equipment, and/or any other type of equipment based on the total occupancy. In some embodiments, HVAC controller 812 can turn off lights if the total occupancy is zero. In some embodiments, HVAC controller 812 can control HVAC equipment based on the total; occupancy. In some embodiments, HVAC controller 812 may determine a load based on the number of occupants. The load may be an amount of heat generated by the occupants (e.g., BTUs). Based on the load HVAC controller 812 can heat and/or cool the zone based on the load. For example, in the winter when HVAC controller 812 is heating the zone, a high load may indicate that the HVAC equipment does not need to generate as number heat since a plurality of occupants are generated heat. In the summer, a high load may indicate that the cooling equipment needs to work harder to cool the zone since there may be a high amount of heat being generated by the occupants.

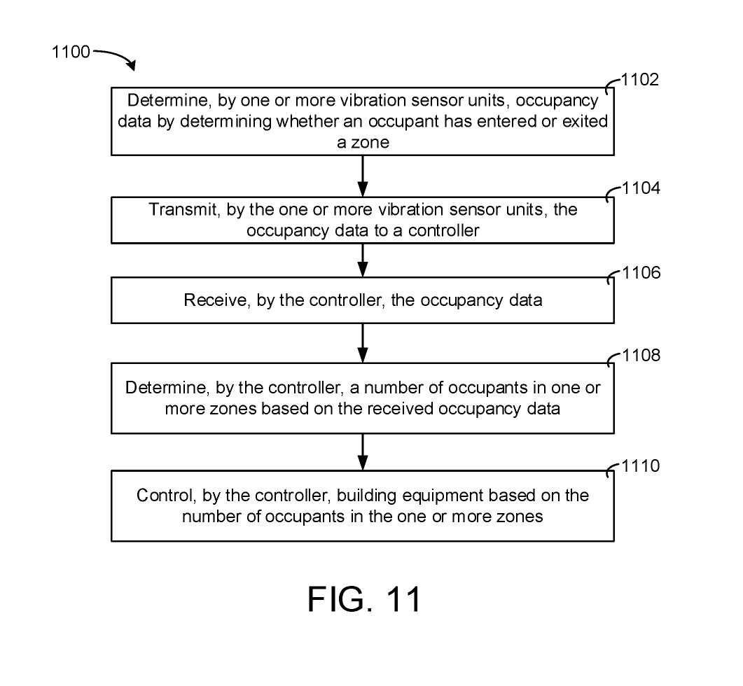

Referring now to FIG. 11, a process 1100 for determining the occupancy of one or more zones by a controller is shown, according to an exemplary embodiment. Vibration sensor units 504a-f and/or controller 502 can be configured to perform process 1100. Process 1100 can be performed by any computing device described herein.

In step 1102, one or more vibration sensor units (e.g., vibration sensor units 504a-f) can determine occupancy data. The occupancy data may indicate that an occupant, or a plurality of occupants, have entered and/or exited a zone. The vibration sensor units can determine the occupancy data based on process 1000 as described with reference to FIG. 10 and/or via any other method for determining whether an occupant has entered or exited a zone as described herein. The one or more vibration sensor units can transmit, in step 1104, the occupancy data determined by each of the one or more vibration sensor units in step 1102 to a controller, controller 502. Controller 502 may be a building controller, a thermostat, a smart actuator, a variable refrigerant flow (VRF) controller, a VAV controller, etc.

In step 1106, controller 502 can receive the occupancy data determined step 1102. Based on the received occupancy data, controller 502 can determine the total number of occupants in one or more zones. Controller 502 may store associations between one or more of the vibration sensor units and one or more of the zones. In this regard, if one or more vibration sensor units associated with a particular zone indicate that an occupant has entered a zone, controller 502 can increment a total occupancy for the zone. This may be necessary since a zone may have a plurality of exit and entry points. A zone with three entry and exit points may have three vibration sensor units associated with the zone.

Based on the occupancy of each of the one or more zones, controller 502 can control building equipment (e.g., HVAC equipment, security equipment, emergency equipment, lighting equipment, etc.). In some embodiments, step 1110 is the same and/or similar to step 1012. In some embodiments, controller 502 may send the occupancy for each zone to a thermostat and/or other controller associated with each of the zones, thus allowing a local controller to control the HVAC equipment associated with the zone.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. An occupancy sensing device for determining occupancy of a zone of a building, the device comprising:
a first vibration sensor configured to sense vibrations associated with movement of an occupant and generate a first signal based on the sensed vibrations;
a second vibration sensor configured to sense the vibrations associated with the movement of the occupant and generate a second signal based on the sensed vibrations; and
a processing circuit configured to:
receive the first signal from the first vibration sensor and determine a first magnitude of the first signal;
receive the second signal from the second vibration sensor and determine a second magnitude of the second signal;
determine whether the occupant is entering or exiting the zone based on the first magnitude and the second magnitude over a first period of time and a second period of time following the first period of time by:
determining that the occupant is entering the zone in response to determining that the first magnitude is greater than the second magnitude for the first period of time and that the second magnitude is greater than the first magnitude for the second period of time following the first period of time; and
determining that the occupant is exiting the zone in response to determining that the first magnitude is less than the second magnitude for the first period of time and that the first magnitude is greater than the second magnitude for the second period of time following the first period of time; and
control equipment associated with the zone based on the whether the occupant is entering or exiting the zone.

2. The device of claim 1, wherein the first vibration sensor and the second vibration sensor are located a predefined distance apart, wherein the predefined distance is between one inch and five feet.

3. The device of claim 1, wherein the first vibration sensor and the second vibration sensor are located in a position that is at least one of under a floor of the building, on top of the floor of the building, and within the floor of the building.

4. The device of claim 1, wherein the occupancy sensing device is located at an entry or exit point of the zone, wherein the first and second vibration sensors sense vibrations associated with the occupant walking on a floor.

5. The device of claim 1, wherein the first vibration sensor and the second vibration sensor are located under a floor of the building at a door frame, wherein the first vibration sensor and the second vibration sensor are located in a line orthogonal with a vertical plane formed by a threshold of the door frame, wherein the first vibration sensor is located outside the zone and the second sensor is located within the zone.

6. The device of claim 1, wherein the first vibration sensor and the second vibration sensor are positioned such that the distance between the occupant and the first vibration sensor is greater than the distance between the occupant and the second vibration sensor as the occupant exits the zone;
wherein the first vibration sensor and the second vibration sensor are positioned such that the distance between the occupant and the second vibration sensor is greater than the distance between the occupant and the first vibration sensor as the occupant enters the zone.

7. The device of claim 1, wherein the first vibration sensor and the second vibration sensor are positioned such that the first signal leads the second signal in time when the occupant enters the zone and the second signal leads the first signal in time when the occupant exits the zone;
wherein the processing circuit is configured to determine, for the first period of time and the second period of time, whether the first signal leads the second signal in time or the second signal leads the first signal in time;
wherein the processing circuit is configured to determine whether the occupant is entering or exiting the zone based on the first magnitude and the second magnitude over the first period of time and the second period of time and further based on whether the first signal leads the second signal in time or the second signal leads the first signal in time over the first period of time and the second period of time.

8. The device of claim 1, wherein the processing circuit is configured to determine a number of occupants in the zone by:
incrementing the number of occupants in the zone in response to determining that the occupant is entering the zone; and
decrementing the number of occupants in the zone in response to determining that the occupant is exiting the zone.

9. The device of claim 8, wherein the processing circuit is configured to control the equipment associated with the zone based on the number of occupants in the zone.

10. The device of claim 8, wherein the processing circuit is configured to:
determine a load based on the number of occupants in the zone; and
control the equipment associated with the zone based on the load, wherein the equipment comprises heating, ventilation, and air-conditioning (HVAC) equipment.

11. (canceled)

12. The device of claim 1, wherein the processing circuit is configured to communicate occupancy data to a controller, wherein the occupancy data comprises information indicating whether the occupant is entering or exiting the zone.

13. A method for determining the occupancy of a zone, the method comprising:
receiving a first signal from a first vibration sensor, wherein the first signal is generated by the first vibration sensor based on vibrations associated with movement of an occupant;
determining a first magnitude of the first signal;
receiving a second signal from a second vibration sensor, wherein the second signal is generated by the second vibration sensor based on the vibrations associated with the movement of the occupant;
determining a second magnitude of the second signal;
determining whether the occupant is entering or exiting the zone based on the first magnitude and the second magnitude over a first period of time and a second period of time following the first period of time by:
determining that the occupant is entering the zone in response to determining that the first magnitude is greater than the second magnitude for the first period of time and that the second magnitude is greater than the first magnitude for the second period of time following the first period of time; and
determining that the occupant is exiting the zone in response to determining that the first magnitude is less than the second magnitude for the first period of time and that the first magnitude is greater than the second magnitude for the second period of time following the first period of time;
determining a number of occupants in the zone based on whether the occupant is entering or exiting the zone; and
controlling equipment associated with the zone based on the number of occupants in the zone, wherein the equipment comprises heating, ventilation, and air-conditioning (HVAC) equipment.

14. The method of claim 13, wherein the first vibration sensor and the second vibration sensor are positioned such that the first signal leads the second signal in time when the occupant enters the zone and the second signal leads the first signal in time when the occupant exits the zone;
wherein the method further comprises determining, for the first period of time and the second period of time, whether the first signal leads the second signal in time or the second signal leads the first signal in time;
wherein determining whether the occupant is entering or exiting the zone based on the first magnitude and the second magnitude over the first period of time and the second period of time is further based on whether the first signal leads the second signal in time or the second signal leads the first signal in time over the first period of time and the second period of time.

15. The method of claim 13, wherein the method further comprises determining the number of occupants in the zone by:
incrementing the number of occupants in the zone in response to determining that the occupant is entering the zone; and
decrementing the number of occupants in the zone in response to determining that the occupant is exiting the zone.

16. A system for sensing occupancy in a zone of a building, the system comprising:
a first vibration sensor configured to sense vibrations associated with movement of an occupant and generate a first signal based on the sensed vibrations;
a second vibration sensor configured to sense the vibrations associated with the movement of the occupant and generate a second signal based on the sensed vibrations;
wherein the first vibration sensor and the second vibration sensor are located a predefined distance apart;
wherein the first and second vibration sensors are located at an entry or exit point of the zone and configured to sense vibrations associated with the occupant walking on a floor; and
a processing circuit configured to:
receive the first signal from the first vibration sensor and determine a first magnitude of the first signal;
receive the second signal from the second vibration sensor and determine a second magnitude of the second signal;
determine whether the occupant is entering or exiting the zone based on the first magnitude and the second magnitude over a first period of time and a second period of time following the first period of time by:
determining that the occupant is entering the zone in response to determining that the first magnitude is greater than the second magnitude for a first period of time and that the second magnitude is greater than the first magnitude for a second period of time following the first period of time; and
determining that the occupant is exiting the zone in response to determining that the first magnitude is less than the second magnitude for the first period of time and that the first magnitude is greater than the second magnitude for the second period of time following the first period of time; and
control equipment associated with the zone based on the whether the occupant is entering or exiting the zone by communicating occupancy data to a controller, wherein the controller is configured to receive the occupancy data and control the equipment based on the received occupancy data, wherein the occupancy data comprises information indicating whether the occupant is entering or exiting the zone.

17. The system of claim 16, wherein the first vibration sensor and the second vibration sensor are located under the floor at a door frame, wherein the first vibration sensor and the second vibration sensor are located in a line orthogonal with a vertical plane formed by a threshold of the door frame, wherein the first vibration sensor is located outside the zone and the second sensor is located within the zone.

18. The system of claim 16, wherein the first vibration sensor and the second vibration sensor are positioned such that the distance between the occupant and the first vibration sensor is greater than the distance between the occupant and the second vibration sensor as the occupant exits the zone;
wherein the first vibration sensor and the second vibration sensor are positioned such that the distance between the occupant and the second vibration sensor is greater than the distance between the occupant and the first vibration sensor as the occupant enters the zone.

19. The system of claim 16, wherein the first vibration sensor and the second vibration sensor are positioned such that the first signal leads the second signal in time when the occupant enters the zone and the second signal leads the first signal in time when the occupant exits the zone;
wherein the processing circuit is configured to determine, for the first period of time and the second period of time, whether the first signal leads the second signal in time or the second signal leads the first signal in time;
wherein the processing circuit is configured to determine whether the occupant is entering or exiting the zone based on the first magnitude and the second magnitude over the first period of time and the second period of time and further based on whether the first signal leads the second signal in time or the second signal leads the first signal in time over the first period of time and the second period of time.

20. The system of claim 16, wherein the processing circuit is configured to determine a number of occupants in the zone by:
incrementing the number of occupants in the zone in response to determining that the occupant is entering the zone; and
decrementing the number of occupants in the zone in response to determining that the occupant is exiting the zone.

21. The method of claim 13, wherein the first vibration sensor is located outside the zone and the second sensor is located within the zone.
